(19) United States
(12) Patent Application Publication
(10) Pub. No.: US 2022/0105735 A1
(43) Pub. Date: Apr. 7, 2022

(54) Structure To Remove Jam By Opening Conveying Path Around Conveying Roller

(71) Applicant: Hewlett-Packard Development Company, L.P., Spring, TX (US)

(72) Inventors: SeungSup Lee, Suwon (KR); Youngsoo Ko, Suwon (KR); Byung-Jun Lee, Suwon (KR)

(73) Assignee: Hewlett-Packard Development Company, L.P., Spring, TX (US)

(21) Appl. No.: 17/297,410

(22) PCT Filed: Jan. 31, 2020
(86) PCT No.: PCT/US2020/016088

§ 371 Date: May 26, 2021

(30) Foreign Application Priority Data
Jun. 28, 2019 (KR) 10-2019-0078332

(51) Int. Cl. B41J 11/00; B65H 5/38

(52) U.S. Cl. CPC B41J 11/006; B65H 5/38; B65H 2402/441; B65H 2801/06; B65H 2601/321; B65H 2404/611; B65H 2601/111; B65H 2402/45

(57) ABSTRACT

An example jam removal structure can include a transporting roller transporting a print medium along a transporting path, an Inner-side guide, and first and second guides facing the inner-side guide to form the transporting path and located in an upstream side and a downstream side of the transporting roller based on a transport direction of the print medium to be rotatable to an open position opening the transporting path and a path formation position forming the transporting path. The example jam removal structure can include an operating lever connected to each of the first and second guides by first and second connecting members to switch the first and second guides to the open position or the path formation position and an elastic member applying an elastic force to the first and second guides in a direction rotating toward the path formation position.

### BACKGROUND

An image forming apparatus prints an image on a print medium transported along a transporting path by a transporting roller. For example, an electrophotographic image forming apparatus irradiates light onto a photoconductor charged to have a uniform electric potential to form an electrostatic latent image and supplies a toner to the electrostatic latent image to form a toner image on the photoconductor. The toner image is transferred to the print medium transported along the transporting path and when the print medium passes through a fusing unit, the toner image is fixed on the print medium as a permanent image by heat and pressure.

A print medium not being properly transported in the transporting path is called a jam. The transporting path is opened to treat the jam.

### BRIEF DESCRIPTION OF THE DRAWINGS

FIG. 1 is a schematic configuration diagram of an example of an image forming apparatus;

FIG. 2 is a perspective view of an example of a jam treating structure;

FIG. 3 is a cross-sectional view illustrating a state in which first and second guides are located in a path formation position in an example of the jam treating structure shown in FIG. 2;

FIG. 4 is a cross-sectional view illustrating a state in which first and second guides are located in an open position in an example of the jam treating structure shown in FIG. 2;

FIG. 5 is a cross-sectional view of an example of a jam treating structure;

FIG. 6 is a cross-sectional view illustrating a state in which a first guide is located in a second open position in an example of the jam treating structure shown in FIG. 5

FIG. 7 is a cross-sectional view illustrating a state in which a second guide is located in a third open position in an example of the jam treating structure shown in FIG. 5;

FIG. 8 is a cross-sectional view of an example of a jam removal structure;

FIG. 9 is a cross-sectional view of an example of a jam removal structure;

FIG. 10 is a partial perspective view illustrating a state in which first and second guides are located in a path formation position in an example of a jam removal structure;

FIG. 11 is a partial perspective view illustrating a state in which the first and second guides are located in an open position in an example of the jam removal structure;

FIG. 12 is a perspective view of an example of a locking unit;

FIG. 13 is a diagram illustrating a state in which a gear unit and a latch unit are engaged in an example of the locking unit shown in FIG. 12;

FIG. 14 is a diagram illustrating a state in which a latch unit is apart ro a gear unit in an example of the locking unit shown in FIG. 12; and

FIG. 15 is a schematic configuration diagram of an example of an image forming apparatus.

### DETAILED DESCRIPTION OF EXAMPLES

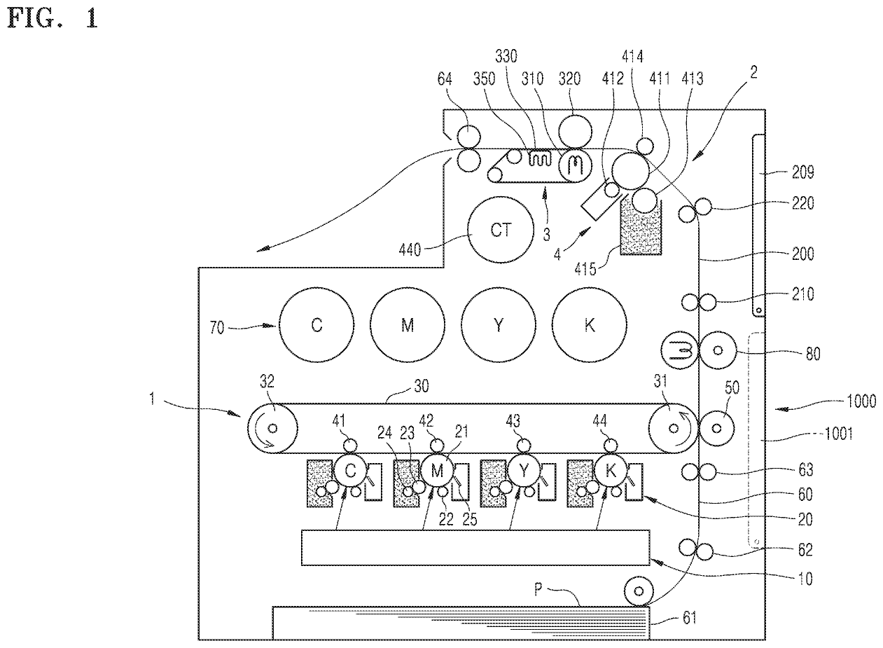

FIG. 1 is a schematic configuration diagram of an example of an image forming apparatus. Referring to FIG. 1, the image forming apparatus may include a printing unit 1 forming a recording image on a print medium P by an electrophotographic method and a photofinisher 2 located above the printing unit 1 and forming an image (e.g., a clear image) covering the recording image of the print medium P output from the printing unit 1. The photofinisher 2 may include a clear toner coating unit 4 coating the print medium P with a clear toner CT and a photofinishing unit 3 cooling the print medium P after applying heat and pressure to the print medium P coated with the clear toner CT. The image forming apparatus of the present example includes the photofinisher 2 as a single body in a main body 1000 including the printing unit 1. A printing unit may also be referred to as a “printing device”.

The printing unit 1 of the present example can form a recording image on the print medium P by an electrophotographic method. In an example, the printing unit 1 may include an exposure device 10, a developing device 20, a transfer unit, and a fusing unit 80.

For color printing, the developing device 20 may include four developing devices 20 to develop images of cyan C, magenta M, yellow Y, and black K colors. Each of the toners of cyan C, magenta M, yellow Y, and black K colors may be accommodated in four toner supply containers 70 and each of the toners of cyan C, magenta M, yellow Y, and black K colors may be supplied from the four toner supply containers 70 to the four developing devices 20, Hereinafter, unless otherwise specified, reference symbols C, M, Y. and K refer to a configuration component for developing the images of cyan C, magenta M, yellow Y, and black K colors.

The developing device 20 can supply a toner to an electrostatic latent image formed on a photoconductive drum 21 to develop the electrostatic latent image into a visible toner image. The developing device 20 may include the photoconductive drum 21 on which an electrostatic latent image is formed. A charging roller 22 is an example of a charger that may charge the photoconductive drum 21 to have a uniform electric surface electric potential, Other types of cleaning members such as a rotatable brush or the like may be used instead of a cleaning blade 25, The developing device 20 of the present example may use a one-component developing method using a toner as a developing agent. A developing bias voltage may be applied to a developing roller 23 to supply the toner to the photoconductive drum 21. A supply bias voltage may be applied to a supply roller 24 to supply the toner in the developing device 20 to a surface of the developing roller 23. The developing device 20 may further include a regulating member (not shown) to regulate an amount of toner attached to the surface of the developing roller 23 and supplied to a development nip in which the photoconductive drum 21 and the developing roller 23 are in contact with each other. The regulating member may be, for example, a doctor blade, which is in elastic contact with the surface of the developing roller 23.

The exposure device 10 can irradiate light modulated according to image information to the photoconductive drum 21 to form an electrostatic latent image on a surface of the photoconductive drum 21.

The transfer unit may include an intermediate transfer belt 30, intermediate transfer rollers 41, 42, 43, and 44, and a transfer roller 50. The intermediate transfer belt 30 can be supported by support rollers 31 and 32 to be circulated. The four intermediate transfer rollers 41, 42, 43, and 44 can be respectively located at a position facing the photoconductive drum 21 of each the developing devices 200, 20M, 20Y, and 20K, and the intermediate transfer belt 30 can be arranged between the photoconductive drums 21 of the developing devices 200, 20M, 20Y, and 20K and the four intermediate transfer rollers 41, 42, 43, and 44. A transfer bias voltage may be applied to the four intermediate transfer rollers 41, 42, 43, and 44 to intermediately transfer the toner image developed on the photoconductive drum 21 to the intermediate transfer belt 30. In some examples, a transfer roller 50 is located to face the intermediate transfer belt 30. A transfer bias voltage can be applied to the transfer roller 50 to transfer the toner image intermediately transferred to the intermediate transfer belt 30 to the print medium P.

When a print command is received from a host or the like (not shown in FIG. 1), a controller (not shown) can use a charging roller 22 to charge a surface of the photoconductive drum 21 to have a uniform electric potential. The exposure device 10 can irradiate four light beams modulated according to image information of each color to the photoconductive drums 21 of the developing devices 200, 20M, 20Y, and 20K to form electrostatic latent images on the photoconductive drums 21. The developing rollers 23 of each of the developing devices 200, 20M, 20Y, and 20K can respectively supply toners of C, M, Y, and K colors to the photoconductive drums 21 of the developing devices 20C, 20M, 20Y, and 20K to develop the electrostatic latent images into visible toner images. Developed toner images can be overlapped and transferred and overlapped on the intermediate transfer belt 30.

The print medium P withdrawn from a supply tray 61 by a pickup roller can be transported along a transporting path 60 by transporting rollers 62 and 63. The transporting roller 63 can align with a front end of the print medium P and transport the print medium P such that a front end of the print medium reaches a transfer nip formed by the transfer roller 50 and the intermediate transfer belt 30 when a front end of the toner image transferred to the intermediate transfer belt 30 reaches the transfer nip. In some examples, the transporting roller 63 can be referred to as a registration roller. As used herein, “aligning with the front end of the print medium P” means correcting a skew of the print medium P.

The toner images transferred and overlapped on the intermediate transfer belt 30 can be transferred to the print medium P by the transfer bias voltage applied to the transfer roller 50, in some examples.

The fusing unit 80 can apply heat and pressure to the print medium P on which the toner image is transferred to fix the toner image on the print medium P. When the print medium P, on which the toner image is transferred, passes through a fusing nip, the toner image can be fixed on the print medium P by heat and pressure. Accordingly, a recording image can be formed on the print medium P in the printing unit 1.

The print medium P, on which the recording image is formed in the printing unit 1, can be transported to the photofinisher 2. As described above; the photofinisher 2 may include the clear toner coating unit 4 and the photofinishing unit 3.

The clear toner coating unit 4 can coat the print medium P with the clear toner CT to cover the recording image. The clear toner coating unit 4 may coat an entire image surface of the print medium P with the clear toner CT, In this case, a non-exposure electrophotographic method may be used in the clear toner coating unit 4.

Referring to FIG. 1, the clear toner coating unit 4 may include a container 415 in which the clear toner CT is accommodated, a charge receiving member 411, a charge supplying member 412, a developing member 413, and a transfer member 414.

The charge supplying member 412 can charge the charge receiving member 411. In some examples, the developing member 413 attaches the clear toner CT accommodated in the container 415 to the charge receiving member 411. A developing bias voltage can be applied to the developing member 413 to develop the clear toner CT into the charge receiving member 411. The transfer member 414 can face the charge receiving member 411 with the print medium P between the transfer member 414 and the charge receiving member 411 and can transfer the clear toner CT attached to the charge receiving member 411 to the print medium P. A transfer bias voltage having a polarity opposite to a charging polarity of the clear toner CT can be applied to the transfer member 414 in some examples. The clear toner CT may be supplied from a clear toner container 440 to the container 415.

The photofinishing unit 3 may include a heating roller 310, a pressing roller 320, a belt 330, and a cooling device 350. The heating roller 310 can face the image surface of the print medium P and can apply heat to the recording image and the clear toner image fixed on the image surface of the print medium P. To this end, the heating roller 310 may be heated by a heat source (not shown). A halogen lamp, a heat-resistance coil, an induction heater, a ceramic heater, or the like may be used as the heat source in some examples. The pressing roller 320 can form a heating nip with the heating roller 310 with the belt 330 between the pressing roller 320 and the heating roller 310 and can apply pressure to the image surface of the print medium P passing through the heating nip to closely contact the image surface of the print medium P on the belt 330.

The print medium P, in some examples, is supported by the belt 330 after passing through the heating nip. The belt 300 may have a thickness having the flexibility to be circulated by the heating roller 310 and support rollers.

The cooling device 350 can cool the print medium P passing through the heating nip. In an example, the cooling device 350 may include a heat sink in contact with an inner surface of the belt 330. In an example, the cooling device 350 may include a duct located inside the belt 330 and a blower supplying air to the duct. An air discharge port opened toward the belt 330 may be provided in the duct.

The transporting rollers 210 and 220 can transport the print medium P output from the printing unit 1 along the transporting path 200. In some examples, the transporting roller 220 can align with the front end of the print medium P and transport the print medium to the transfer nip formed by the charge receiving member 411 and the transfer member 414 such that the front end of the print medium P reaches the transfer nip when a front end of the clear toner image developed on the charge receiving member 411 reaches the transfer. The transporting roller 220 may be referred to as a registration roller.

The clear toner image in the transfer nip can be transferred to the image surface of the print medium P. The print medium P can be transported to the photofinishing unit 3. The print medium P can be pressed against an outer surface of the belt 330 by a pressing force supplied by the pressing roller 320. In some examples, the recording image and the clear toner CT on the image surface of the print medium P can be heated and melted by a thermal energy provided by the heating roller 310 while passing through the heating nip. The print medium P, which passed through the heating nip, can be rapidly cooled by the cooling device 350. Accordingly, a clear image covering the recording image may be formed.

The outer surface of the belt 330 can be a smooth surface with reduced surface roughness. As described above, the recording image and the clear toner CT can be pressed against the outer surface of the belt 330 by receiving thermal energy and pressure in the heating nip, and a surface roughness of the image surface can be lowered. In some examples, when the surface roughness of the image surface is lowered, a ratio of diffuse light among light reflected from the image surface can be reduced and a ratio of specular light can be increased, and thus, a glossiness of a printed image may be increased. A rapid cooling of the print medium P may improve a glossiness of the printed image.

In some examples, the print medium P separated from the belt 330 may be discharged outside the main body 1000 by a discharge roller 64. Accordingly, a printed image with improved glossiness may be obtained.

According to the image forming apparatus of the present example, the photofinisher 2 may be located above the printing unit 1. The print medium P output from the printing unit 1 and drawn into the photofinisher 2 can be transported through the transporting path 200 extending in a vertical direction. The front end of the print medium P can be aligned by an alignment roller 220 and can be transported to the clear toner coating unit 4. In some instances, when there is a jam in the transporting path 200 around the alignment roller 220, the transporting path 200 may be opened to remove the jam. For example, the transporting path 200 may be opened by opening an upper portion of the photofinisher 2 and removing the clear toner coating unit 4. According to the image forming apparatus of the present example, because the photofinisher 2 is above the printing unit 1, the height of the image forming apparatus may be increased. It may not be easy to open the transporting path 200 by removing the clear toner coating unit 4 from an upper side of the image forming apparatus. In addition, it may not be easy to remove a jam by accessing the transporting path 200 from the upper side of the image forming apparatus.

Considering the above description, the image forming apparatus of the present example can include a structure in which the transporting path 200 may be accessed from a side portion of the image forming apparatus. As shown in FIG. 1, a side door 230 can be provided in the side portion of the image forming apparatus. A jam may be removed by opening the side door 209 to access the transporting path 200 from the side portion of the image forming apparatus.

Hereinafter, examples of a jam removal structure opening and closing the transporting path 200 will now be described below.

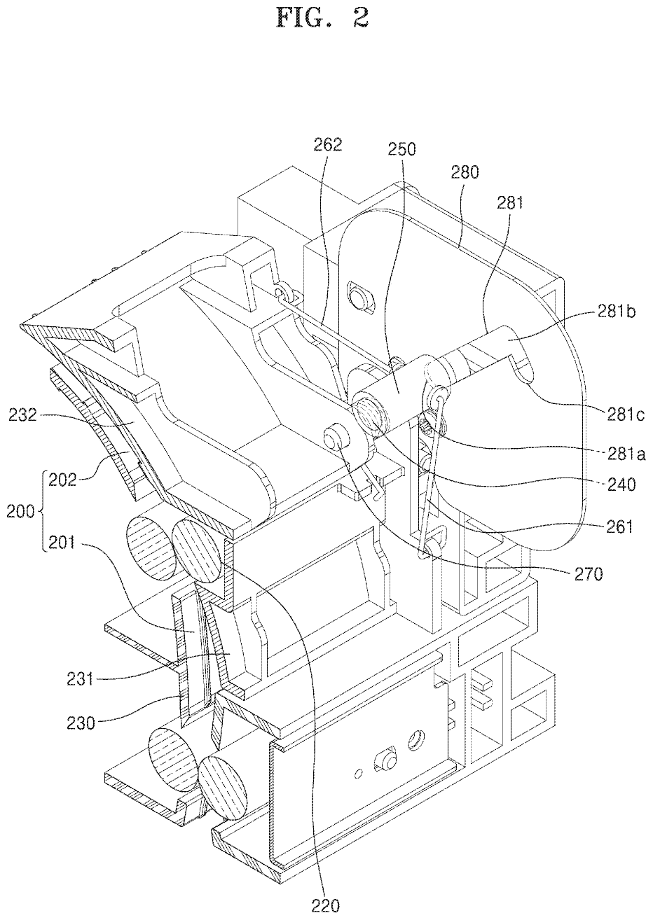

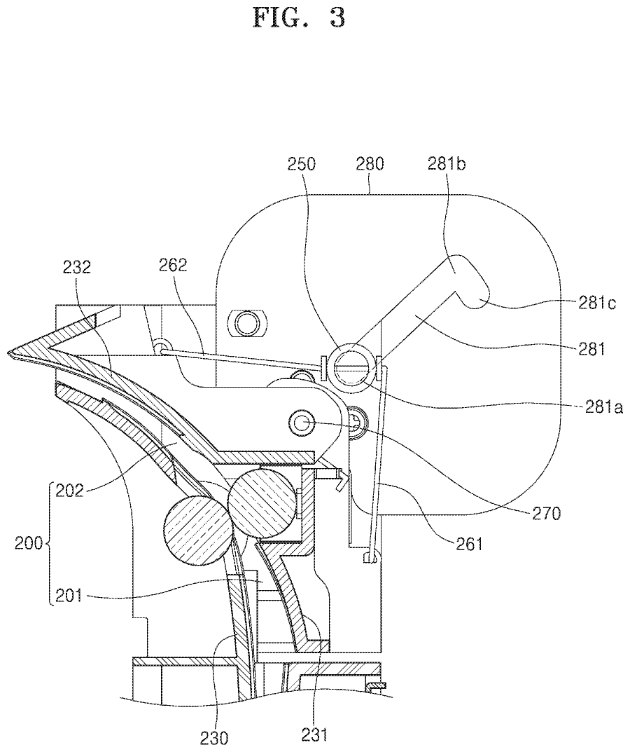

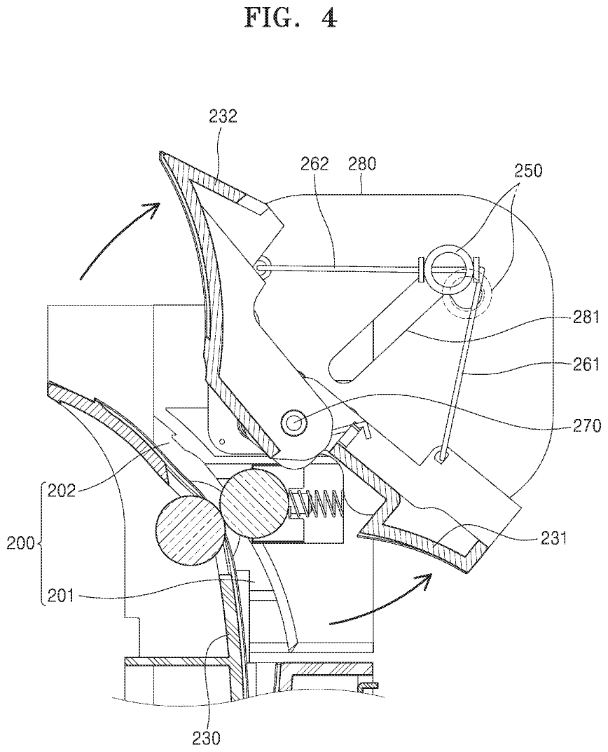

FIG. 2 is a perspective view of an example of a jam treating structure. FIG. 3 is a cross-sectional view illustrating a state in which first and second guides 231 and 232 are located in a path formation position in an example of the jam treating structure shown in FIG. 2. FIG. 4 is a cross-sectional view illustrating a state in which the first and second guides 231 and 232 are located in an open position in an example of the jam treating structure shown in FIG. 2.

Referring to FIGS. 2, 3, and 4, the jam treating structure may include the alignment rollers 220, an inner-side guide 230, the first and second guides 231 and 232, an elastic member 240, an operating lever 250, and first and second connecting members 261 and 262.

The alignment rollers 220 can be engaged with each other and rotate to transport the print medium P along the transporting path 200. The transporting path 200 can be formed by the inner-side guide 230 and the first and second guides 231 and 232. The inner-side guide 230 can extend in the vertical direction and form an inner side wall of the transporting path 200. In some examples, the first and second guides 231 and 232 extend in the vertical direction and face the inner-side guide 230 to form the transporting path 200. The first and second guides 231 and 232 can form an outer-side wall of the transporting path 200. The first guide 231 can be located in an upstream side 201 of the alignment rollers 220 based on a transport direction of the print medium P. The second guide 232 can be located in a downstream side 202 of the alignment rollers 220 based on the transport direction of the print medium P.

In some examples, the first and second guides 231 and 232 may be rotated to an open position (FIG. 4) opening the transporting path 200 and a path formation position (FIG. 3) forming the transporting path 200. For example, the first and second guides 231 and 232 may be rotated to the open position and the path formation position around a rotation shaft 270, which can be common to the first and second guides 231 and 232. The rotation shaft 270 may be located adjacent to the alignment rollers 220 The rotation shaft 270 may have a form extending in an axial direction of the alignment rollers 220.

The elastic member 240 can apply an elastic force in a direction in which the first and second guides 231 and 232 are rotated to the path formation position. For example, the elastic member 240 may include a torsion coil spring having a winding unit inserted into the rotation shaft 270 and two arms respectively connected to the first and second guides 231 and 232. Although not illustrated in FIG. 2, the elastic member 240 may include a compression coil spring or a tension coil spring applying pressure to or pulling each of the first and second guides 231 and 232 to be rotated to the open position.

In some examples, the operating lever 250 switches the first and second guides 231 and 232 from the path formation position to the open position. The operating lever 250 can be connected to the first and first and second guides 231 and 232 by the first and second connecting members 261 and 262. The first and second connecting members 261 and 262 may include a wire having one end and the other end, also referred to as “another end,” respectively connected to the first and second guides 231 and 232 and the operating lever 250. The wire may be a flexible wire. The first and second connecting members 261 and 262 may be one flexible wire. For example, an end of the flexible wire may be connected to the first connecting member 261, a portion of the flexible wire may be wrapped around the operating lever 250 or fixed to the operating lever 250, and the other end of the flexible wire may be connected to the second connecting member 262.

In some instances, the operating lever 250 may have a first switching position switching the first and second guides 231 and 232 to the open position and a return position returning the first and second guides 231 and 232 to the path formation position. The operating lever 250 may be, for example, supported by a supporting member 280. The operating lever 250 may be supported by the supporting member 280 to be moved to the first switching position and the return position. A first operating groove 281 guiding the operating lever 250 to the first switching position and the return position may be provided in the supporting member 280. The first operating groove 281 may have one end 281a close to the rotation shaft 270 and the other end 281b far from the rotation shaft 270. For example, the first operating groove 281 may extend in a radial direction around the rotation shaft 270. The one end 281a and the other end 281b of the first operating groove 281 may respectively correspond to the return position and the first switching position of the operating lever 250.

In some examples, when there is a jam in the transporting path 200, the side door 209 is opened. This can result in the first and second guides 231 and 232 and the operating lever 250 being exposed, and a user may access the operating lever 250 from the side portion of the image forming apparatus. As shown in FIG. 3, the first and second guides 231 and 232 can be maintained at the path formation position by the elastic force of the elastic member 240. The operating lever 250 may be located in the return position. In other words, the operating lever 250 may be located in one end 281a of the first operating groove 281. The user can access the operating lever 250 from the side portion of the image forming apparatus and can move the operating lever 250 along the first operating groove 281 to the other end 281b of the first operating groove 281. In some examples, as the operating lever 250 is moved to the other end 281b of the first operating groove 281, the first and second guides 231 and 232 can be rotated around the rotation shaft 270 from the path formation position to the open position. As shown in FIG. 4, when the operating lever 250 reaches the first switching position, the first and second guides 231 and 232 can reach the open position, and the upstream side 201 and the downstream side 202 of the transporting path 200 may be open. Accordingly, a jammed print medium P may be removed from the transporting path 200.

After removing the jammed print medium P, the operating lever 250 can be returned to the return position along the first operating groove 281. The first and second guides 231 and 232 can be returned from the open position to the path formation position by the elastic force of the elastic member 240.

As described above, because the user may operate the operating lever 250 to switch the first and second guides 231 and 232 from the path formation position to the open position in a state in which the side door 209 is opened, a jam removing job may be easier than a case where an upper door (not shown) of the photofinisher 2 is opened.

Referring to FIGS. 2, 3, and 4 again, a first locking groove 281c locking the operating lever 250 to the first switching position may be provided in the supporting member 280. For example, the first locking groove 281c may extend in a circumferential direction from the other end 281b of the first operating groove 281 around the rotation shaft 270. A force in a direction toward the return position can be applied to the operating lever 250 by the elastic force of the elastic member 240, and a direction of the force toward the rotation shaft 270, for instance, the radial direction. In some examples, because the first locking groove 281c extends from the other end 281b of the first operating groove 281 in the circumferential direction, the operating lever 250 may be caught in the first locking groove 281c and maintained in the first switching position.

According to the above structure, since the first and second guides 231 and 232 may be maintained in the open position, the jam removing job may be performed with reduced difficulty as compared to other jam removal jobs. In some examples, because the first locking groove 281c extends from the other end 281b of the first operating groove 281 in a direction toward the first guide 231, when the operating lever 250 is located in the first locking groove 281c, the first guide 231 may be located in a position slightly rotated toward the path formation position from the open position and the second guide 232 may be located in a position slightly further rotated from the open position in a direction opposite to the path formation position.

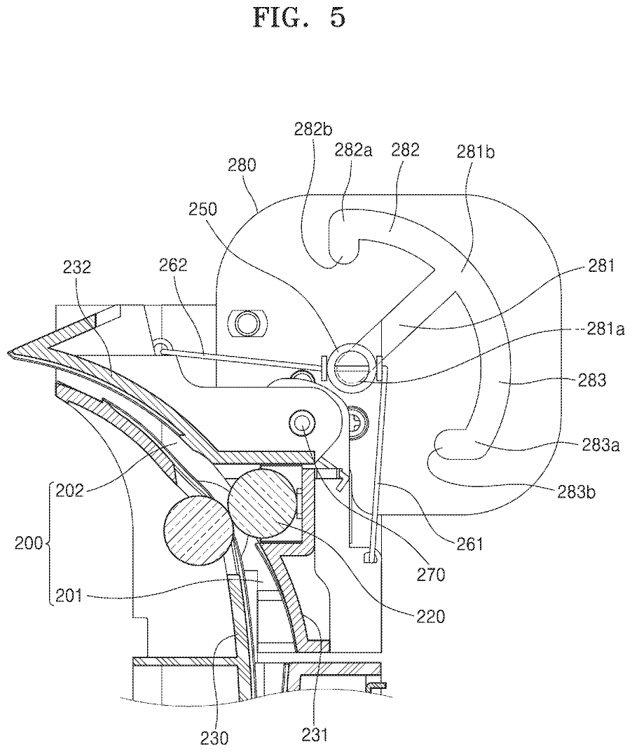

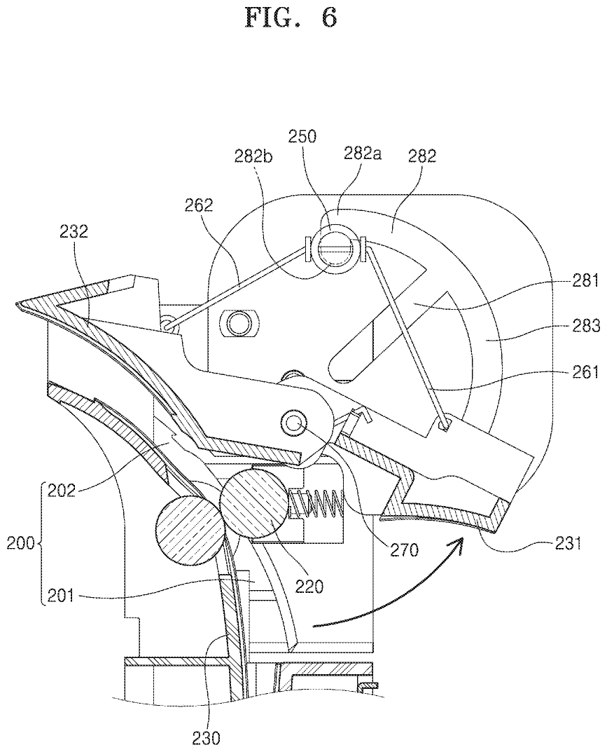

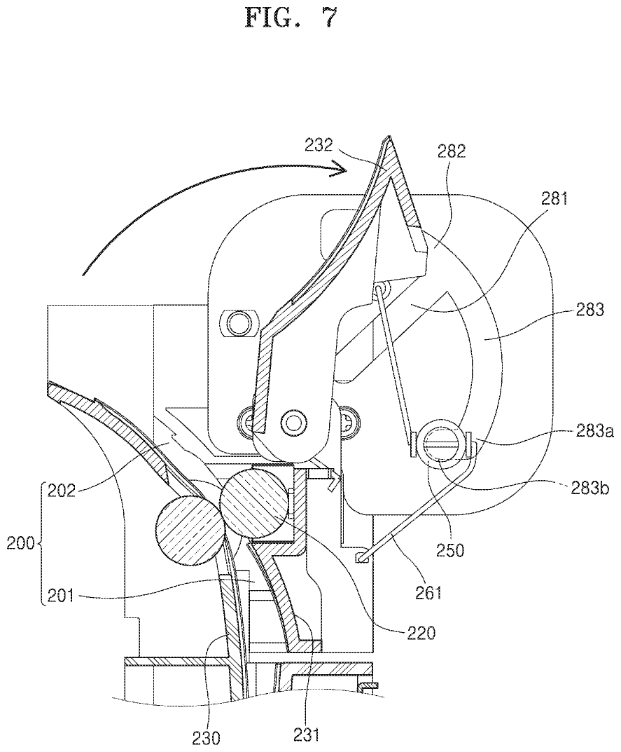

A structure rotating the first and second guides 231 and 232 to a position having a greater opening angle than that of the open position may be included. FIG. 5 is a cross-sectional view of an example of a jam treating structure, FIG. 6 is a cross-sectional view illustrating a state in which the first guide 231 is located in a second open position in an example of the jam treating structure shown in FIG. 5 FIG. 7 is a cross-sectional view illustrating a state in which the second guide 232 is located in a third open position in an example of the jam treating structure shown in FIG. 5.

Referring to FIGS. 5, 6, and 7, the operating lever 250 may have the first switching position switching the first and second guides 231 and 232 to the open position and the return position returning the first and second guides 231 and 232 to the path formation position. The operating lever 250 may have a second switching position switching the first guide 231 to a second open position (FIG. 6) having a greater opening angle than that of the open position. The operating lever 250 may have a third switching position switching the second guide 232 to a third open position (FIG. 7) having a greater opening angle than that of the open position.

The operating lever 250 may be supported by the supporting member 280. The operating lever 250 may be supported by the supporting member 280 to be moved to the first switching position and the return position. In some examples, the operating lever 250 may be supported by the supporting member 280 to be moved from the first switching position to the second switching position and the third switching position.

The first operating groove 281 guiding the operating lever 250 to the first switching position and the return position can be provided in the supporting member 280. The first operating groove 281 may have one end 281a close to the rotation shaft 270 and the other end 281b far from the rotation shaft 270. For example, the first operating groove 281 may extend in the radial direction around the rotation shaft 270. The one end 281a and the other end 281b of the first operating groove 281 may respectively correspond to the return position and the first switching position of the operating lever 250.

A second operating groove 282 guiding the operating lever 250 to the second switching position may be provided in the supporting member 280. The second operating groove 282 of the present example can guide the operating lever 250 from the first switching position to the second switching position. The second operating groove 282 may extend from the first operating groove 281. The second operating groove 282 may extend from the other end 281b of the first operating groove 281 in a direction far from the first guide 231. For example, the second operating groove 282 may extend from the other end 281b of the first operating groove 281 in the circumferential direction around the rotation shaft 270.

A second locking groove 282b locking the operating lever 250 to the second switching position may be provided in the supporting member 280. For example, the second locking groove 282b may extend in the radial direction from one end 282a of the second operating groove 282 around the rotation shaft 270. A force in a direction toward the return position from the second switching position through the first switching position can be applied to the operating lever 250 by the elastic force of the elastic member 240. In some examples, because the second locking groove 282b extends from the one end 282a of the second operating groove 282 in the radial direction, the operating lever 250 may be caught in the second locking groove 282b and maintained in the second switching position.

According to the above structure, because the first guide 231 may be maintained in the second open position, the jam removing job may be performed with less difficulty as compared to other jam removal jobs.

A third operating groove 283 guiding the operating lever 250 to the third switching position may be provided in the supporting member 280. The third operating groove 283 of the present example can guide the operating lever 250 from the first switching position to the third switching position. The third operating groove 283 may extend from the first operating groove 281. The third operating groove 283 may extend from the other end 281b of the first operating groove 281 in a direction far from the second guide 232. For example, the third operating groove 283 may extend from the other end 281b of the first operating groove 281 in the circumferential direction around the rotation shaft 270.

A third locking groove 283b locking the operating lever 250 to the third switching position may be provided in the supporting member 280. For example, the third locking groove 283b may extend in the radial direction from one end 283a of the third operating groove 283 around the rotation shaft 270. A force in a direction toward the return position from the third switching position through the first switching position can be applied to the operating lever 250 by the elastic force of the elastic member 240. In some examples, because the third locking groove 283b extends from the one end 283a of the third operating groove 283 in the radial direction, the operating lever 250 may be caught in the third locking groove 283b and maintained in the third switching position. According to the above structure, since the second guide 232 may be maintained in the third open position, the jam removing job may be performed with less difficulty as compared to other jam removing jobs.

In some examples, when there is a jam in the transporting path 200, the side door 209 can be opened. As a result, the first and second guides 231 and 232 and the operating lever 250 may be exposed and the user may access the operating lever 250 from the side portion of the image forming apparatus. As shown in FIG. 5, the first and second guides 231 and 232 may be maintained in the path formation position by the elastic force of the elastic member 240. The operating lever 250 is located in the return position. In other words, the operating lever 250 can be located in the one end 281a of the first operating groove 281. The user can access the operating lever 250 from the side portion of the image forming apparatus and can move the operating lever 250 along the first operating groove 281 to the other end 281b of the first operating groove 281. In some examples, as the operating lever 250 is moved to the other end 281b of the first operating groove 281, the first and second guides 231 and 232 can be rotated, around the rotation shaft 270, from the path formation position to the open position. As shown in FIG. 4, when the operating lever 250 reaches the first switching position, the first and second guides 231 and 232 can reach the open position, and the upstream side 201 and the downstream side 202 of the transporting path 200 may all be open. Accordingly, the jammed print medium P may be removed from the transporting path 200.

After removing the jammed print medium P, the operating lever 250 can be returned to the return position along the first operating groove 281. The first and second guides 231 and 232 can be returned from the open position to the path formation position by the elastic force of the elastic member 240.

In some examples, when the first and second guides 231 and 232 are located in the open position and space for removing the jam is not secured, the first and second guides 231 and 232 may be located in the second open position or the third open position.

For example, as shown in FIG. 6, the operating lever 250 can be moved along the second operating groove 282 to the end 282a of the second operating groove 282. Then, the operating lever 250 can reach the second switching position and the first guide 231 can reach from the open position to the second switching position, which is further open. In this state, because the upstream side 201 of the transporting path 200 may be widely open, a jam in the upstream side 201 of the transporting path 200 may be removed. In a state where the first guide 231 is located in the second open position, the second guide 232 may be located in a position slightly rotated from the open position toward the path formation position as shown in FIG. 6. Although not illustrated in FIG. 6, the second guide 232 may be located in the path formation position. When the operating lever 250 is located in the second locking groove 282b, because the operating lever 250 may be locked in the second switching position, a jam in the upstream side 201 of the transporting path 200 may be removed.

For example, as shown in FIG. 7, the operating lever 250 may be moved along the third operating groove 283 to the end 283a of the third operating groove 283. Then, the operating lever 250 can reach the third switching position and the second guide 232 can reach from the open position to the third switching position, which may be further open. In this state, since the downstream side 202 of the transporting path 200 may be widely open, a jam in the downstream side 202 of the transporting path 200 may be removed. In a state where the second guide 232 is located in the third open position, the first guide 231 may be located in the path formation position as shown in FIG. 7. Although not illustrated in FIG. 7, the first guide 231 may be located in a position slightly rotated from the open position toward the path formation position. When the operating lever 250 is located in the third locking groove 283b, because the operating lever 250 may be locked in the third switching position, a jam in the downstream side 202 of the transporting path 200 may be removed.

In an example of the jam removal structure shown in FIGS. 5 to 7, the second operating groove 282 and the third operating groove 283 extend from the other end 281b of the first operating groove 281 and the operating lever 250 is moved to the second switching position or the third switching position through the first switching position.

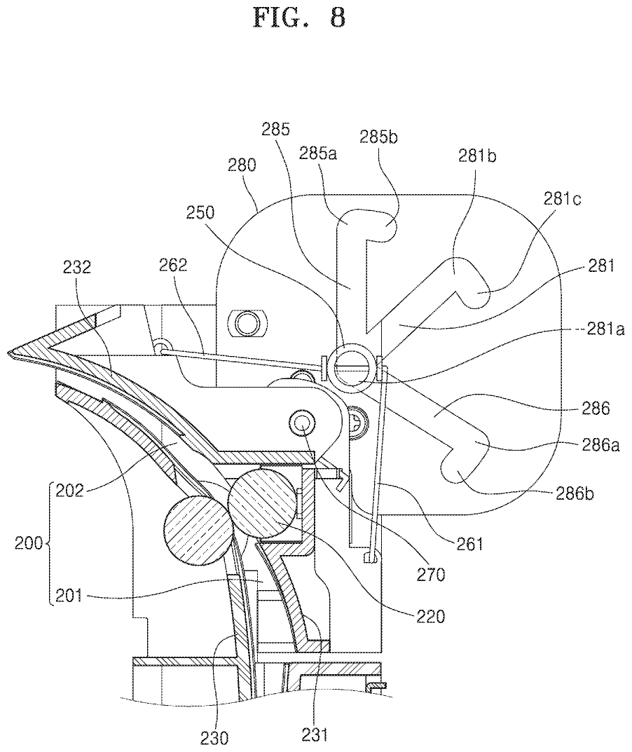

FIG. 8 is a cross-sectional view of an example of a jam removal structure. Referring to FIG. 8, in the jam removal structure of the present example, a second operating groove 285 and a third operating groove 286 can extend from the end 281a of the first operating groove 281 in the radial direction. Accordingly, the operating lever 250 may be moved from the return position to the second switching position or the third switching position without passing through the first switching position. In addition, the operating lever 250 may be moved from the second switching position or the third switching position to the return position without passing through the first switching position. The first locking groove 281c may extend from the other end 281b of the first operating groove 281 in the circumferential direction. The second locking groove 285b and the third locking groove 286b may respectively extend from the one end 285a of the second operating groove 285 and the one end 286a of the third operating groove 286 in the circumferential direction.

According to the above structure, the first and second guides 231 and 232 may be simultaneously switched to the open position by locating the operating lever 250 in the first switching position. In addition, the first and second guides 231 and 232 may be selectively switched to the second open position or the third open position by selectively locating the operating lever 250 in the second switching position or the third switching position.

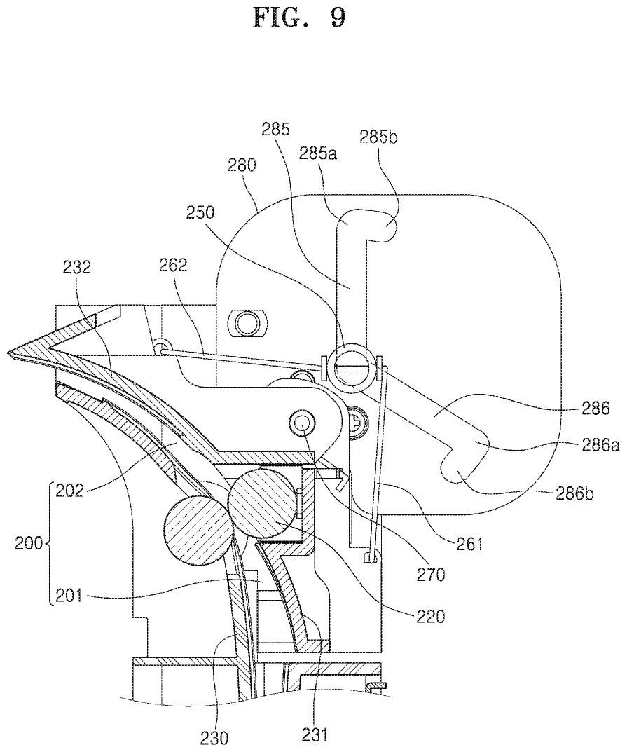

FIG. 9 is a cross-sectional view of an example of a jam removal structure. Referring to FIG. 9, the open position can include a fourth open position where the first guide 231 is opened and a fifth open position where the second guide 232 is opened. The fourth open position and the fifth open position may respectively correspond to the above-described second open position and the third open position. The operating lever 250 may be moved from the return position to a fourth switching position switching the first guide 231 to the second open position. The operating lever 250 may be moved from the return position to the fifth switching position switching the second guide 232 to the third open position.

An example of the jam removal structure shown in FIG. 9 may be in a state that the first operating groove 281 is removed in an example of the jam removal structure shown in FIG. 8. Accordingly, hereinafter, the second operating groove 285 is referred to as a fourth operating groove 285, the third operating groove 286 is referred to as a fifth operating groove 286, the second locking groove 285b is referred to as a fourth locking groove 285b, and the third locking groove is referred to as a fifth locking groove 286b. The fourth operating groove 285 guiding the operating lever 250 from the return position to the second switching position and the fifth operating groove 286 guiding the operating lever 250 from the return position to the third switching position can be provided in the supporting member 280. For example, the fourth operating groove 285 and the fifth operating groove 286 may extend from a common end close to the rotation shaft 270 in the radial direction. The fourth locking groove 285b and the fifth locking groove 286b respectively maintaining the operating lever 250 in the second switching position and the third switching position may respectively extend from an end 285a of the fourth operating groove 285 and an end 286a of the fifth operating groove 286 in the circumferential direction. According to the above structure, the first and second guides 231 and 232 may be selectively switched to the fourth open position or the fifth open position by selectively locating the operating lever 250 in the second switching position or the third switching position.

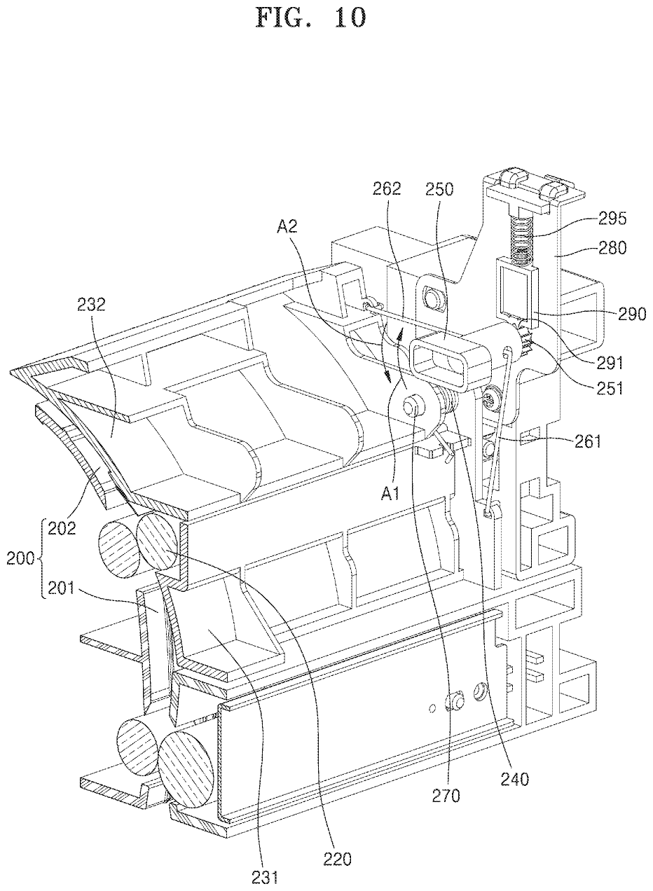

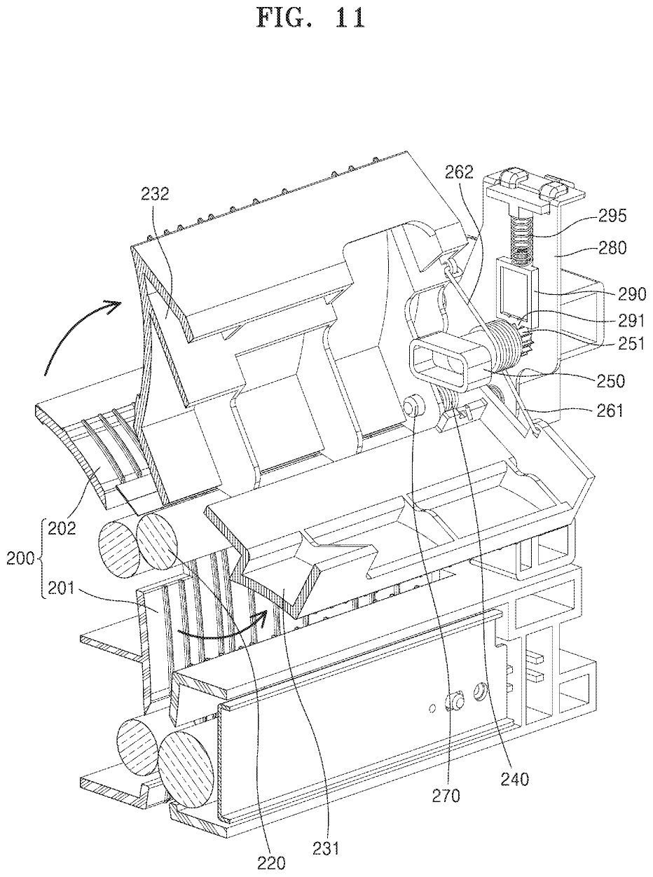

FIG. 10 is partial perspective view illustrating a state in which the first and second guides 231 and 232 are located in a path formation position in an example of a jam removal structure; and FIG. 11 is a partial perspective view illustrating a state in which the first and second guides 231 and 232 are located in an open position in an example of the jam removal structure. In the jam removal structure of the present example, the first and second guides 231 and 232 being switched to the path formation position and the open position by rotating the operating lever 250 is different from the jam removal structure shown in FIGS. 2 to 9. Hereinafter, differences between the jam removal structure shown in FIGS. 2 to 9 and the jam removal structure of the present example will be mainly described below.

Referring to FIGS. 10 and 11, the operating lever 250 can be supported to be rotatable in the supporting member 280. The operating lever 250 may be rotated in a first direction A1 switching the first and second guides 231 and 232 from the path formation position to the open position and a second direction A2 opposite to the first direction A1.

Ends of the first and second connecting members 261 and 262 can be respectively connected to the first and second guides 231 and 232 and the other ends of the first and second connecting members 261 and 262 can be connected to the operating lever 250. The first and second connecting members 261 and 262 may include a wire wrapped on the operating lever 250 as shown in FIG. 11 or a wire released from the operating lever 250 as shown in FIG. 10 according to a rotational direction of the operating lever 250. Accordingly, the first and second guides 231 and 232 may be switched from the path formation position to the open position by rotating the operating lever 250. The wire may be a flexible wire in some examples.

According to the above structure, the first and second guides 231 and 232 may be rotated to have a proper opening angle by adjusting the amount of rotation of the operating lever 250.

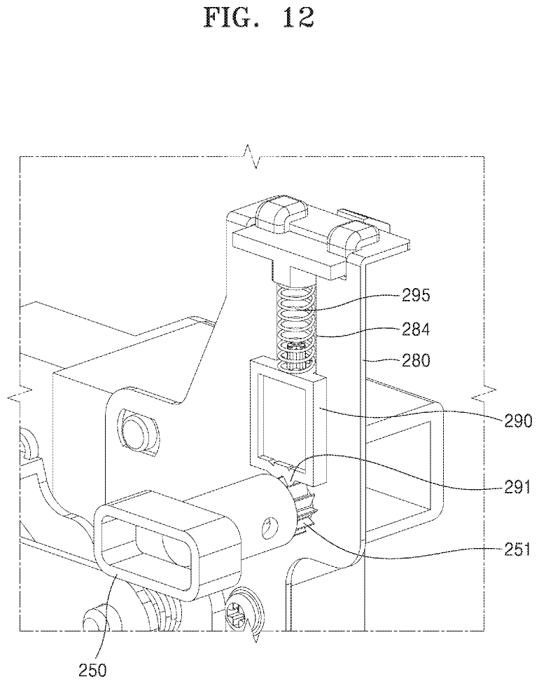

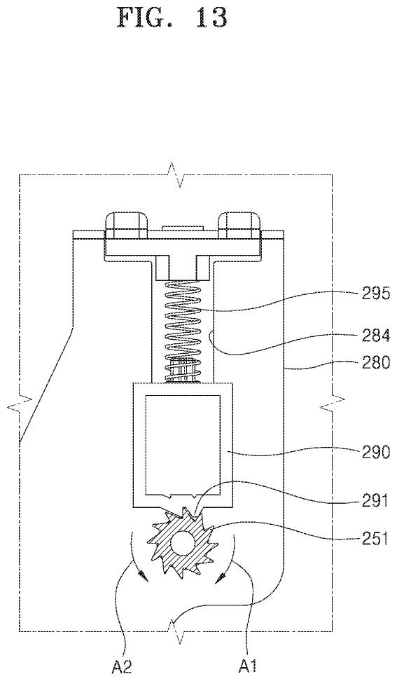

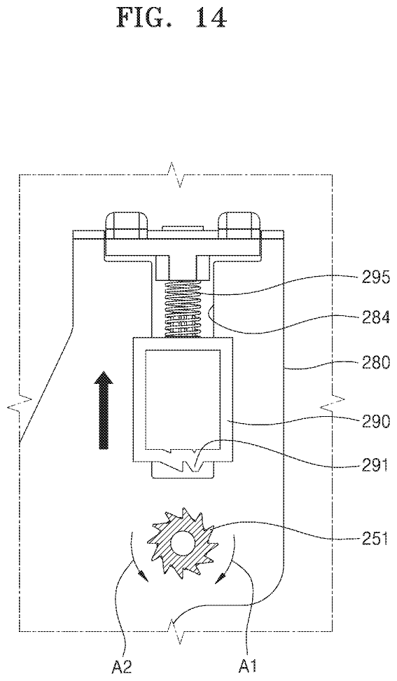

The jam removal structure may include a locking unit locking the first and second guides 231 and 232 to the open position. FIG. 12 is a perspective view of an example of a locking unit. FIG. 13 is a diagram illustrating a state in which a gear unit 251 and a latch unit 291 are engaged in an example of the locking unit shown in FIG. 12. FIG. 14 is a diagram illustrating a state in which the latch unit 291 is apart from the gear unit 251 in an example of the locking unit shown in FIG. 12. The latch unit may also be referred to as a “latch device”, and the gear unit may also be referred to as a “gear device”.

Referring to FIGS. 12 to 14, the locking unit of an example may include the gear unit 251 provided in the operating lever 250, a fixing member 290 supported by the supporting member 280 to be elevated or lowered relative to the gear unit 251 and having the latch unit 291 engaged with the gear unit 251 to allow a rotation of the operating lever 250 in the first direction A1 and block a rotation of the operating lever 250 in the second direction AZ and a locking spring 295 providing an elastic force, to the fixing member 290, in a direction in which the latch unit 291 is engaged with the gear unit 251.

For example, a fixing member 290 may be supported by a guide rail 284 provided in the supporting member 280 to be elevated and lowered. The locking spring 295 may include, for example, a compression coil spring having one end and the other end respectively supported by the supporting member 280 and the fixing member 290. As shown in FIGS. 13 and 14, the gear unit 251 can be an inclined gear inclined toward the second direction A2 and the latch unit 291 is inclined to correspond an inclined direction of the gear unit 251.

As shown in FIG. 13, the locking spring 295 can apply pressure to the fixing member 290 toward the gear unit 251 and the latch unit 291 can maintain a state engaged with the gear unit 251. In this state, when the operating lever 250 is rotated in the first direction A1, because the gear unit 251 is inclined in the second direction A2, the latch unit 291 is pushed, by the gear unit 251, in a direction opposite to an elastic force of the locking spring 295. The operating lever 250 may be rotated in the first direction A1 while the fixing member 290 is lifted upward.

According to the above structure, when the operating lever 250 is rotated in the first direction A1, the first and second guides 231 and 232, as shown in FIG. 11, can be rotated from the path formation position to the open position while the first and second connecting members 261 and 262 wrap around the operating lever 250. The upstream side 201 and the downstream side 202 of the transporting path 200 can be opened. When a rotation of the operating lever 250 stops, the first and second guides 231 and 232 can be applied with an elastic force by the elastic member 240 in a direction toward the path formation position. The elastic force of the elastic member 240 can act as a force to rotate the operating lever 250 in the second direction A2. In some examples, because the gear unit 251 has a shape inclined in the second direction A2, the operating lever 250 may not be rotated in the second direction A2 by a wedging action of the gear unit 251 and the latch unit 291. Accordingly, the first and second guides 231 and 232 may be maintained in the open position.

When the jam is removed, the fixing member 290 can be lifted in a direction opposite to the elastic force of the locking spring 295 to separate the latch unit 291 from the gear unit 251. The operating lever 250 can then be rotated in the second direction A2 by the elastic force of the elastic member 240 and the first and second guides 231 and 232 can be returned from the open position to the path formation position.

In the above examples, although the structure for removing jams occurs near the alignment roller 220 of the photofinisher 2, the examples of the above-stated jam removal structure may be used as a structure for removing jams generated near the alignment roller 63 of the printing unit 1. The examples of the above-stated jam removal structure may also be used in a structure in which a transporting roller is installed in a transporting path extending in a vertical direction. In this case, a door 1001 partially or entirely opening the main body 1000 to access the operating lever 250 may be provided in the side portion of the main body 1000.

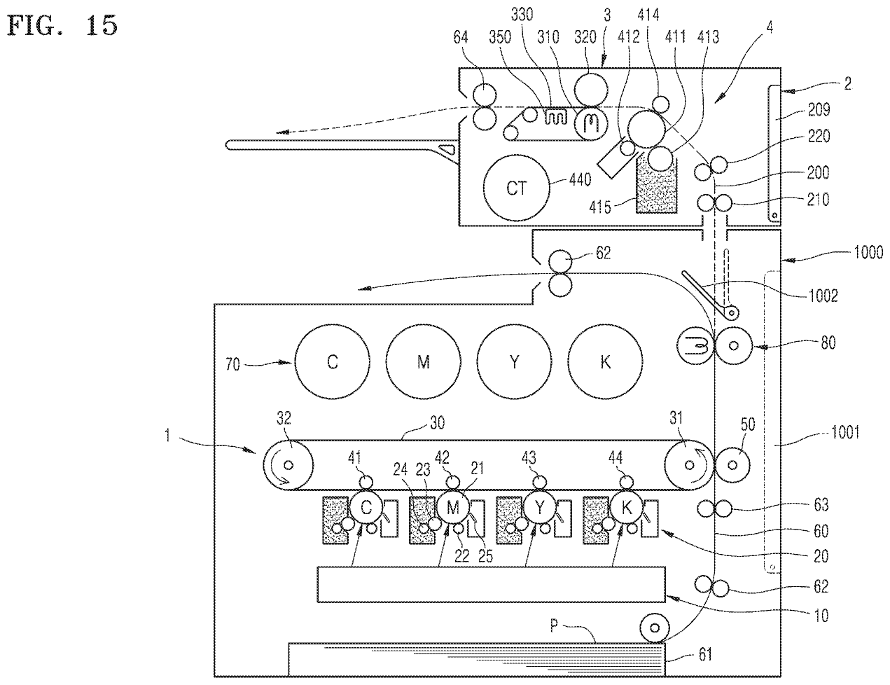

The photofinisher 2 may have a structure detachable from the main body 1000. FIG. 15 is a schematic configuration diagram of an example of an image forming apparatus. The image forming apparatus of the present example includes the main body 1000, the main body 1000 having the printing unit 1, and the photofinisher 2. The photofinisher 2 may be detachable from the main body 1000.

The image forming apparatus may further include a path selection member 1002 located in an exit of the fusing unit 80 and selectively guiding the print medium P to the photofinisher 2. The path selection member 1002 may be switched to, by a driving unit (e.g., a solenoid) a first position (a position shown by the solid line) directly discharging the print medium P, which passed through the fusing unit 80, from the main body 1000 without being treated with glossiness and a second position (a position shown by the dashed line) guiding the print medium P, which passed through the fusing unit 80, to the photofinisher 2. According to the above structure, glossiness treatment may be selectively performed. In other words, when a paper with high glossiness is used as a print medium P, the path selection member 1002 can be located in the first position and the print medium P, which passed through the fusing unit 80, may be directly discharged from the main body 1000 without being treated with glossiness. When a general paper with low glossiness is used as a print medium P, when necessary, the path selection member 1002 can be located to the second position to guide the print medium P, which passed through the fusing unit 80, to the photofinisher 2.

The jam removal structure shown in FIGS. 2 to 14 may also be applied to the image forming apparatus shown in FIG. 15.

It should be understood that embodiments described herein should be considered in a descriptive sense and not for purposes of limitation. Descriptions of features or aspects within each embodiment may be considered as available for other similar features or aspects in other embodiments. While embodiments have been described with reference to the figures, it will be understood by those of ordinary skill in the art that various changes in form and details may be made therein without departing from the spirit and scope as defined by the following claims.

What is claimed is:

1. A jam removal structure comprising:
a transporting roller to transport a print medium along a transporting path;
an inner-side guide;
first and second guides facing the inner-side guide to form the transporting path and located in an upstream side and a downstream side of the transporting roller based on a transport direction of the print medium,
wherein the first and second guides are rotatable to an open position that opens the transporting path and a path formation position that forms the transporting path;
an operating lever connected to each of the first and second guides by first and second connecting members to switch the first and second guides to the open position or the path formation position; and
an elastic member to apply an elastic force to the first and second guides in a direction rotating toward the path formation position.

2. The jam removal structure of claim 1, wherein:
the first connecting member comprises a wire having one end and another end respectively connected to the first guide and the operating lever; and
the second connecting member comprises a wire having one end and another end respectively connected to the second guide and the operating lever.

3. The jam removal structure of claim 1, further comprising:
a supporting member on which the operating lever is supported, the supporting member providing therein:
a first operating groove to guide the operating lever to a first switching position to switch the first and second guides to the open position and to a return position to locate the first and second guides to the path formation position.

4. The jam removal structure of claim 3, wherein the supporting member further provides therein:
a first locking groove to lock the operating lever to the first switching position.

5. The jam removal structure of claim 3, wherein the supporting member further provides therein:
a second operating groove to guide the operating lever to a second switching position to switch the first guide to a second open position having a greater opening angle than that of the open position; and
a third operating groove to guide the operating lever to a third switching position to switch the second guide to a third open position having a greater opening angle than that of the open position.

6. The jam removal structure of claim 1, wherein:
the open position comprises a fourth open position in which the first guide is opened and a fifth open position in which the second guide is opened;
the operating lever is supported by the supporting member; and
the supporting member provides therein:
a fourth operating groove to guide the operating lever to the second switching position to switch the first guide to the fourth open position; and
a fifth operating groove to guide the operating lever to the third switching position to switch the second guide to the fifth open position.

7. The jam removal structure of claim 1, further comprising:
a supporting member to rotatably support the operating lever in a first direction to switch the first and second guides from the path formation position to the open position and a second direction opposite to the first direction,
wherein the first and second connecting members comprise wires having one end connected to each of the first and second connecting members and another end connected to the operating lever and wrapped on the operating lever or released from the operating lever according to a rotational direction of the operating lever.

8. The jam removal structure of claim 7, further comprising:
a gear device provided in the operating lever;
a fixing member having a latch device engaged with the gear device to allow a rotation of the operating lever in the first direction and block a rotation in the second direction and supported by the supporting member to be elevated or lowered relative to the gear device; and
a locking spring to provide an elastic force, to the fixing member, in a direction in which the latch device is engaged with the gear device.

9. An image forming apparatus comprising:
a printing device to form a recording image on a print medium; and
a photofinisher located above the printing device to form an image covering the recording image on the print medium output from the printing device, wherein the photofinisher comprises:
a transporting path extending in a vertical direction;
alignment rollers engaged with each other to align the print medium output from the printing device to transport the print medium along the transporting path;
an inner-side guide;
first and second guides facing the inner-side guide to form the transporting path and located in an upstream side and a downstream side of alignment rollers based on a transport direction of the print medium,
wherein the first and second guides are rotatable to an open position that opens the transporting path and a path formation position that forms the transporting path;
an operating lever connected to each of the first and second guides by first and second connecting members to switch the first and second guides to the open position or the path formation position; and
an elastic member to apply an elastic force to the first and second guides in a direction rotating toward the path formation position.

10. The image forming apparatus of claim 9, further comprising:
a supporting member on which the operating lever is supported, the supporting member providing therein:
a first operating groove to guide the operating lever to a first switching position to switch the first and second guides to the open position and to a return position to locate the first and second guides to the path formation position.

11. The image forming apparatus of claim 10, further comprising the supporting member providing therein:
a first locking groove to lock the operating lever to the first switching position.

12. The image forming apparatus of claim 10, further comprising the supporting member providing therein:
a second operating groove to guide the operating lever to a second switching position to switch the first guide to a second open position having a greater opening angle than that of the open position is provided; and
a third operating groove to guide the operating lever to a third switching position to switch the second guide to a third open position having a greater opening angle than that of the open position is provided.

13. The image forming apparatus of claim 9, wherein:
the open position comprises a fourth open position in which the first guide is opened and a fifth open position in which the second guide is opened;
the operating lever is supported by the supporting member; and
the supporting member provides therein:
a fourth operating groove to guide the operating lever to the second switching position to switch the first guide to the fourth open position; and
a fifth operating groove to guide the operating lever to the third switching position to switch the second guide to the fifth open position.

14. The image forming apparatus of claim 9, further comprising:
a supporting member to rotatably support the operating lever in a first direction to switch the first and second guides from the path formation position to the open position and a second direction opposite to the first direction,
wherein the first and second connecting members comprise wires having one end connected to each of the first and second connecting members and another end connected to the operating lever and wrapped on the operating lever or released from the operating lever according to a rotational direction of the operating lever.

15. The image forming apparatus of claim 14, further comprising:
a gear device provided in the operating lever;
a fixing member having a latch device engaged with the gear device to allow a rotation of the operating lever in the first direction and block a rotation in the second direction and supported by the supporting member to be elevated or lowered relative to the gear device which is inclined; and
a locking spring providing an elastic force, to the fixing member, in a direction in which the latch device is engaged with the gear device.
